(19) United States
(12) Patent Application Publication
(10) Pub. No.: US 2025/0282307 A1
(43) Pub. Date: Sep. 11, 2025

(54) STRUCTURE FOR MOUNTING FENDER COVER WITH PILLAR GARNISH

(71) Applicant: Honda Motor Co., Ltd., Tokyo (JP)

(72) Inventors: TIMOTHY J. RUPP, Dublin, OH (US); BRENT N. GAERTNER, Cable, OH (US); DOUGLAS R. KALTENMARK, Powell, OH (US)

(21) Appl. No.: 18/597,501

(22) Filed: Mar. 6, 2024

(51) Int. Cl. B60R 13/02

(52) U.S. Cl. CPC B60R 13/0206

(57) ABSTRACT

A mounting structure for a vehicle is provided. The mounting structure includes a garnish gasket having a first side coupled with a body panel of the vehicle. The mounting structure further includes a first pillar garnish disposed on a second side of the garnish gasket. Further, a first portion of the first pillar garnish meets up with a cowl of the vehicle. The cowl is configured to mount a fender cover such that a gap is formed between the fender cover and a hood frame of the vehicle.

### BACKGROUND

A clamshell hood, also known as a clamshell bonnet in some regions, is a distinctive automotive design feature used in various cars over the years. The clamshell hood is designed to cover engine and incorporate parts of body panel (for example, fenders). The clamshell hood complicates the relationship between A-Pillar and the hood by introducing more hood swing variation and placing swing path close to the A-Pillar. For some instances, installation of a large hinge cover between the hood and the A-Pillar may reduce distance between the hood and the A-Pillar and improve protection for the A-Pillar during hood swing while attaining acceptable wind noise. However, the large hinge cover gives a poor appearance and is expensive. Additionally, or alternatively, a wider distance may be provided between the hood and the A-Pillar to alleviate any concerns about the hood colliding with the A-Pillar. However, the wider distance provides a better appearance at the cost of increased wind noise. This necessitates developing a structure having a simple fender cover without any additional attachment features and improving assembly quality. The structure must provide the smallest distance between the hood and the A-Pillar to reduce wind noise and gives a good appearance with lowest cost.

Limitations and disadvantages of conventional and traditional approaches will become apparent to one of skill in the art, through comparison of described systems with few aspects of the present disclosure, as set forth in the remainder of the present application and with reference to the drawings.

### SUMMARY

According to an embodiment of the disclosure, a mounting structure for a vehicle may be provided. The mounting structure may include a garnish gasket having a first side that may be coupled with a body panel of the vehicle. The mounting structure may further include a first pillar garnish that may be disposed on a second side of the garnish gasket. Further, a first portion of the first pillar garnish may meet up with a cowl of the vehicle. The cowl may be configured to mount a fender cover such that a gap may be formed between the fender cover and a hood frame of the vehicle.

According to another embodiment of the disclosure, a vehicle body having a mounting structure for a vehicle may be provided. The mounting structure may include a garnish gasket having a first side that may be coupled with a body panel of the vehicle. The mounting structure may further include a first pillar garnish that may be disposed on a second side of the garnish gasket. Further, a first portion of the first pillar garnish may meet up with a cowl of the vehicle. The cowl may be configured to mount a fender cover such that a gap may be formed between the fender cover and a hood frame of the vehicle.

According to another embodiment of the disclosure, a method of mounting a fender cover on a cowl of a vehicle may be provided. The method may include coupling a first side of a garnish gasket with a body panel of the vehicle. The method may further include disposing a first pillar garnish on a second side of the garnish gasket. Further, a first portion of the first pillar garnish may meet up with the cowl of the vehicle. The method may further include mounting the fender cover on the cowl, such that a gap is formed between the fender cover and a hood frame of the vehicle.

### BRIEF DESCRIPTION OF THE DRAWINGS

FIG. 1A is a diagram that illustrates an exemplary body panel portion for a mounting structure, in accordance with an embodiment of the disclosure.

FIG. 1B is a diagram that illustrates an exemplary mounting structure about an XX section, in accordance with an embodiment of the disclosure.

FIG. 2 is a diagram that illustrates rib features provided on a top portion of a cowl associated with a mounting structure for a vehicle, in accordance with an embodiment of the disclosure.

FIG. 3 is a scenario diagram that illustrates an exemplary implementation of a mounting structure, in accordance with an embodiment of the disclosure.

FIG. 4 is a flowchart that illustrates an exemplary method of mounting a fender cover on a cowl of a vehicle, in accordance with an embodiment of the disclosure.

The foregoing summary, as well as the following detailed description of the present disclosure, is better understood when read in conjunction with the appended drawings. To illustrate the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Various embodiments of the present disclosure may be found in a mounting structure for a vehicle. The disclosed mounting structure may include a garnish gasket having a first side that may be coupled with a body panel of the vehicle. The disclosed mounting structure may further include a first pillar garnish that may be disposed on a second side of the garnish gasket. Further, a first portion of the first pillar garnish may meet up with a cowl of the vehicle. The cowl may be configured to mount a fender cover such that a gap may be formed between the fender cover and a hood frame of the vehicle.

Traditionally, installation of a large hinge cover between a hood and a A-pillar causes a number of issues. For example, if the large hinge cover is installed between the hood and the A-pillar, the distance between the hood and the A-pillar is reduced with considerable wind noise. However, the cost of installation of the large hood cover is high and gives a poor appearance of additional low gloss visible parts of the large hood cover. In some instances, a wider distance between the hood and the A-pillar is provided which may give a better appearance but includes increased wind noise.

To overcome some of the abovementioned issues, the proposed mounting structure may include the garnish gasket coupled with the body panel of the vehicle that alleviates any concerns about the hood frame colliding with the A-Pillar. The mounting structure may further include the first pillar garnish that meets up with the cowl of the vehicle. Thereafter, the cowl may be configured to mount a fender cover without any additional attachment features that may improve assembly quality. Additionally, the fender cover may be mounted on the cowl such that a gap may be formed between the fender cover and the hood frame of the vehicle. The gap may be a smallest distance between the fender cover and the hood frame that alleviates the wind noise.

Reference will now be made in detail to specific aspects or features, examples of which are illustrated in the accompanying drawings. Wherever possible, corresponding, or similar reference numbers will be used throughout the drawings to refer to the same or corresponding parts.

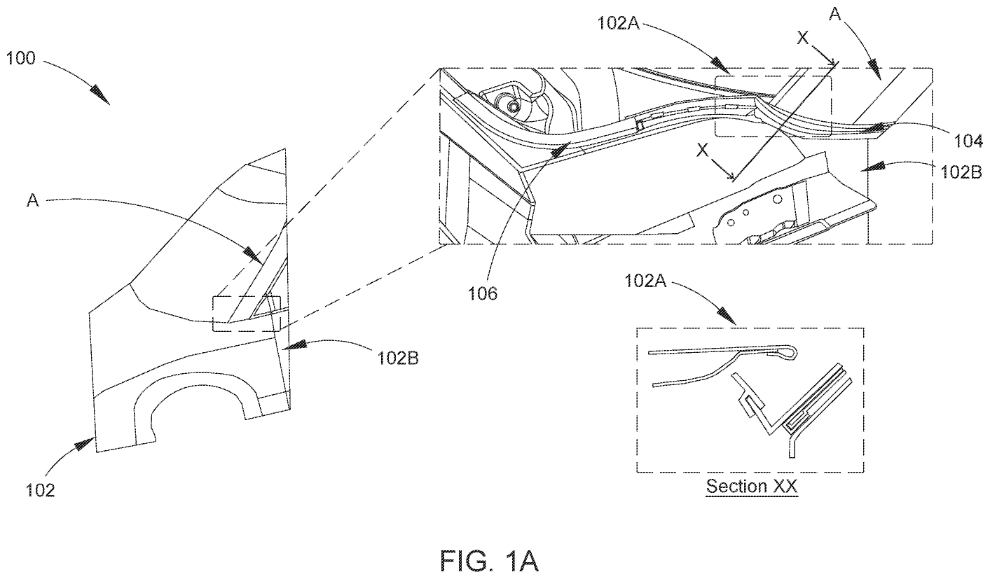

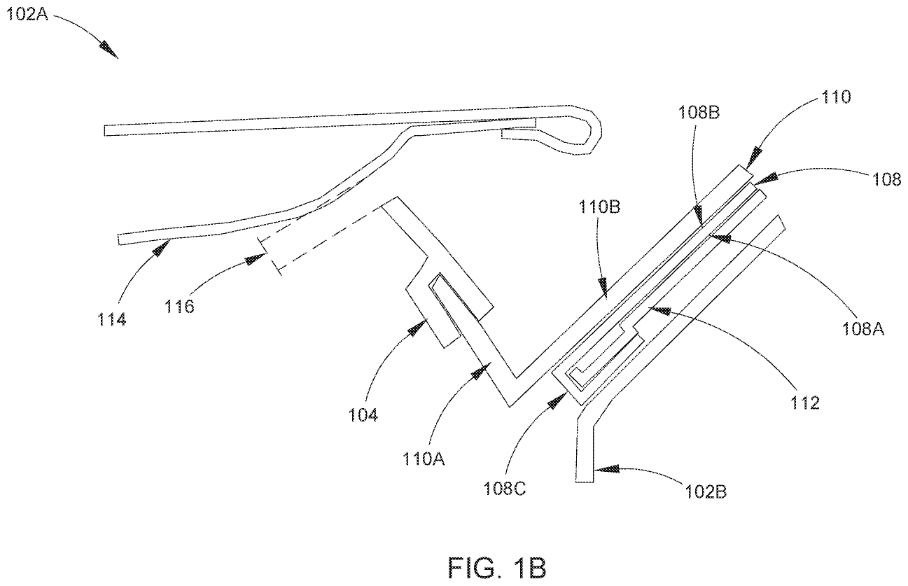

FIG. 1A is a diagram that illustrates an exemplary body panel portion for a mounting structure, in accordance with an embodiment of the disclosure. With reference to the FIG. 1A, there is shown a diagram that illustrates a body panel portion 100 of a vehicle 102 having a mounting structure 102A and a body panel 102B. The body panel portion 100 may further include a A-pillar of the vehicle 102, a fender cover 104, and a cowl 106.

The vehicle 102 may be a means of transport with a clam shell hood, which covers at least one of an engine or portions of body panels associated with the vehicle 102. The vehicle 102 may further include a permanent roof body and a plurality of pillars. Such pillars are critical support structures that connect the vehicle's bottom half to its roof, and vice versa. Roof pillars are denoted by the letters A, B, C, and D from front to back and provide structural strength to the vehicle 102. The A-pillars are located at the front of the vehicle 102, on either side of a front facing windshield. Further, the clam shell hood may introduce more hood swing variation and place swing path close to the A-Pillar of the vehicle. The introduction of the swing path close to the A-pillar may require an opening in a vehicle body, resulting in wind noise. For some instances, a pillar garnish may be placed on the A pillar of the vehicle 102 to seal the opening in the vehicle body. Examples of the vehicle 102 may include, but are not limited to, a four-wheeler vehicle, a three-wheeler vehicle, a hybrid vehicle, a railed vehicle, an amphibious vehicle (for example, screw-propelled vehicle, or hovercraft), an aircraft (for example, planes, helicopters, or aerostats), or a watercraft (for example, ships, or boats) or an underwater vehicle. Examples of the four-wheeler vehicle may include, but are not limited to, an electric car, an internal combustion engine (ICE)-based car, a fuel-cell based car, a solar powered-car, or a hybrid car.

It should be noted here that the four-wheeler vehicle is merely shown as an example in FIG. 1A. The present disclosure may also be applicable to other types of vehicle (for example, a three-wheeled vehicle, an unmanned or manned airborne vehicle, or a seaborne vehicle). The description of other types of the vehicle 102 has been omitted from the disclosure for the sake of brevity.

The mounting structure 102A may be a support structure located at the A-pillar of the vehicle 102, on either side of the vehicle 102 just forward of the rear facing windshield of the vehicle 102. The mounting structure 102A may include the fender cover 104 and the cowl 106 of the vehicle 102. The mounting structure 102A may be attached to the A-pillar of the vehicle 102 using at least one of a seal, glue, or hinge. Further, the mounting structure 102A may be configured to mount the fender cover 104 on the cowl 106 of the vehicle 102 using the garnish gasket 108 (shown in FIG. 1B), as described in detail, for example, in FIG. 1B. In some embodiments, the mounting structure 102A may be disposed on a surface between the C-pillar and the D-pillar.

The body panel 102B may be an assortment of large metal section installed around the vehicle's chassis to provide a critical support to the vehicle 102. The body panel 102B may be disposed on at least lateral sides of the vehicle 102. The lateral sides of the vehicle 102 may be at least a left side or a right side of the vehicle 102, along a length of the vehicle 102. The body panel 102B may provide a solid covering for the vehicle's parts and systems and protect passengers from surrounding elements. Additionally, the body panel 102B may enhance the passenger and driver's overall riding or driving experience. Examples of the body panel 102B may include, but are not limited to, a hood panel, a bumper panel, a fender panel, a header panel, a lower door skin, a wheel arch panel, a quarter panel, or a firewall. The fender panel may be located adjacent to the A-pillar and the cowl 106 of the vehicle 102, on either side of the vehicle 102 just above front tires of the vehicle 102. The fender panel may protect tires and braking systems of the vehicle 102 from mud or other impurities.

The fender panel may include the fender cover 104. The fender cover 104 may be a safety barrier between the fender panel of the vehicle 102 and external objects that might inadvertently cause small or significant damage. The fender cover 104 may be a wheel well which may be positioned over at least a front wheel assembly of the vehicle 102. The fender cover 104 may be mounted over the cowl 106 on either side of the vehicle 102 just above front tires of the vehicle 102. Additionally, the fender cover 104 may protect the at least front wheel assembly of the vehicle 102 from physical damage. In some instances, the fender cover 104 may protect the fender panel from abrasion that may be caused by rubbing against surrounding elements. For example, the fender cover 104 may protect against liquid spills. As another example, the fender cover 104 may protect the fender panel from harmful effects of Ultraviolet rays. By way of example, and not limitation, the fender cover 104 may be made from a material such as neoprene or synthetic leather.

The cowl 106 may be a two layered structure disposed between a rear portion of a front hood and a bottom portion of the rear facing windshield of the vehicle 102. The cowl 106 may be configured to hold wipers associated with the rear facing windshield of the vehicle 102. By way of example, and not limitation, the cowl 106 may collect surrounding elements (for example, leaves, debris, or twigs) and may prevent such elements from entering into engine space of the vehicle 102. The cowl 106 may be configured to mount the fender cover 104 of the vehicle 102.

FIG. 1B is a diagram that illustrates an exemplary mounting structure about an XX section, in accordance with an embodiment of the disclosure. FIG. 1B is explained in conjunction with elements from FIG. 1A. With reference to the FIG. 1B, there is shown a diagram that illustrates the mounting structure 102A about an XX section. The mounting structure 102A may include a garnish gasket 108 having a first side 108A, a second portion 110B, and an L shaped portion 108C. The mounting structure 102A may further include a first pillar garnish 110 having a first portion 110A and a second portion 110B. The mounting structure 102A may further include a second pillar garnish 112, a hood frame 114, and a gap 116 formed between the fender cover 104 and the hood frame 114.

The garnish gasket 108 may be an elastomeric material to establish and hold a static seal between two intersecting surface under diverse operating circumstances. The garnish gasket 108 may be a two-layer structure having an inner layer with a strong sealant properties and workability, and a rubber surface layer with design on it. The garnish gasket 108 may be disposed on the A pillar of the vehicle 102. In accordance with an embodiment, the garnish gasket 108 may be a mechanical seal that, when compressed, fills the gap between two or more mating surfaces to stop leaks into or out of the joined objects. Further, the garnish gasket 108 may be configured to secure the first pillar garnish 110 with the cowl 106 of the vehicle 102 and the second pillar garnish 112 with the body panel 102B of the vehicle 102. The garnish gasket 108 may have the first side 108A, the second side 108B, and the L shaped portion 108C.

The first side 108A of the garnish gasket 108 may substantially face towards the body panel 102B of the vehicle 102 about the XX section. The second side 108B of the garnish gasket 108 may substantially face towards the hood frame 114 about the XX section. In certain instances, the first side 108A and the second side 108B of the garnish gasket 108 may be associated with either a left side or a right side of the garnish gasket 108 along a length of the garnish gasket 108. The first side 108A, as shown in FIG. 1B, may be the right side of the garnish gasket 108. The second side 108B, as shown in FIG. 1B, may be the left side of the garnish gasket 108. Further, the first side 108A of the garnish gasket 108 may be coupled with the body panel 102B of the vehicle 102. By way of example, and not limitation, the first side 108A may be coupled with the body panel 102B using at least one of a nut and bolt, screws, rivets, hinges, or weld. Additionally, the first side 108A may be coupled with the body panel 102B to alleviate any concerns about the garnish gasket 108 colliding with the body panel 102B of the vehicle 102.

The L shaped portion 108C of the garnish gasket 108 may be substantially perpendicular to the first side 108A or the second side 108B of the garnish gasket 108. The L shaped portion 108C may be an extension that may extend from the second side 108B of the garnish gasket 108 and may bend towards the first side 108A of the garnish gasket 108. It should be noted here that the L shaped portion 108C of the garnish gasket 108, as shown in FIG. 1B, is merely an example. The L shaped portion 108C may be configured to receive the second pillar garnish 112 on the first side 108A of the garnish gasket 108. For example, the L shaped portion 108C may form a rectangular cavity with the first side 108A of the garnish gasket 108 that may be configured to receive the second pillar garnish 112. Additionally, the L shaped portion 108C may reduce the gap 116 that may be formed between the fender cover 104 and the hood frame 114 of the vehicle 102.

The first pillar garnish 110 may be a strip of flexible, resilient yet semi-rigid plastic or polymeric resin substance that has been fed into a mold and is allowed to cure to give a shape to the first pillar garnish 110. The material chosen for the first pillar garnish 110 must be stable at ambient temperature throughout the vehicle's operating range. The first pillar garnish 110 may be disposed on the A-pillar of the vehicle 102 and may conform to the shape of the A-pillar. The first pillar garnish 110 may be disposed on the second side 108B of the garnish gasket 108. In FIG. 1B, the first pillar garnish 110 has a non-linear shape, which is merely an example that should not be construed as limiting the disclosure.

In some instances, the first pillar garnish 110 may be disposed on the A-pillar of the vehicle body from an aesthetic perspective. In certain instances, the first pillar garnish 110 may be a safety barrier between the garnish gasket 108 and the hood frame 114 to alleviate any concerns about the garnish gasket 108 colliding with the hood frame 114 of the vehicle 102. The first pillar garnish 110 may have the first portion 110A and the second portion 110B that may be different from the first portion 110A.

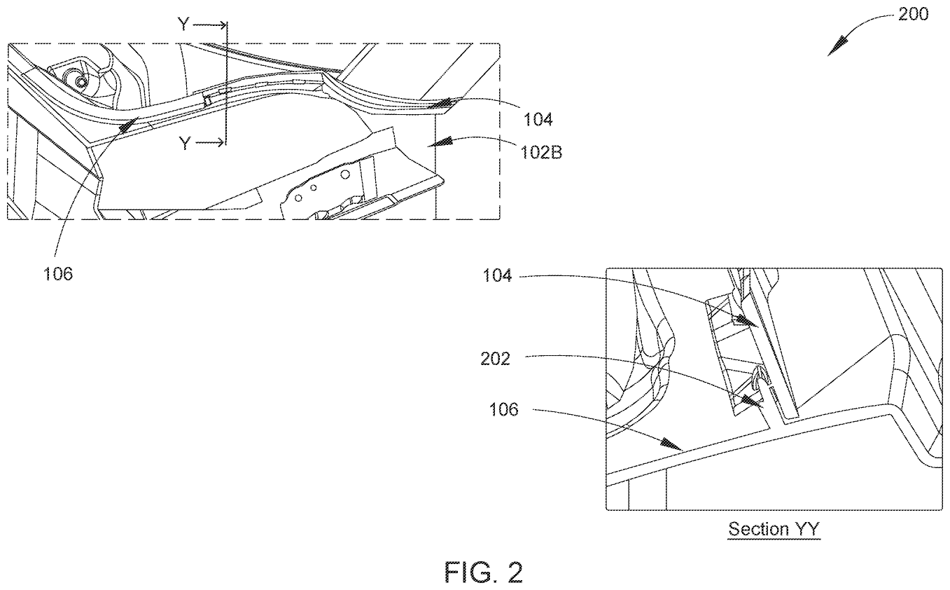

The first portion 110A of the first pillar garnish 110 may substantially face towards the cowl 106 and the hood frame 114 of the vehicle 102. The first portion 110A may extend from the second side 108B of the garnish gasket 108 and may bend towards the hood frame 114 of the vehicle 102. Further, the first portion 110A may meet up with the cowl 106 of the vehicle 102 so that the first portion 110A is substantially flushed with the cowl 106 of the vehicle 102. Additionally, the first portion 110A of the first pillar garnish 110 may reduce the gap 116 that may be formed between the fender cover 104 and the hood frame 114 of the vehicle 102. Further, the cowl 106 may be configured to mount the fender cover 104 without any additional attachment features, as further described in detail, for example, in FIG. 2.

The second portion 110B of the first pillar garnish 110 may be aligned substantially parallel to the second side 108B of the garnish gasket 108. The second portion 110B of the first pillar garnish 110 may be substantially perpendicular to the first portion 110A and may be disposed on the second side 108B of the garnish gasket 108. Additionally, the second portion 110B of the first pillar garnish 110 may secure the second side 108B of the garnish gasket 108.

The second pillar garnish 112 may be a strip of flexible, resilient yet semi-rigid plastic or polymeric resin substance that has been fed into a mold and is allowed to cure to give a shape to the second pillar garnish 112. The material chosen for the second pillar garnish 112 must be stable at ambient temperature throughout the vehicle's operating range. The second pillar garnish 112 may be disposed on the A-pillar of the vehicle 102.

The L shaped portion 108C of the garnish gasket 108 may be configured to receive the second pillar garnish 112 on the first side 108A of the garnish gasket 108. The second pillar garnish 112 may conform to the shape of the L shaped portion 108C. The second pillar garnish 112, as shown in FIG. 1B, has a rectangular shape, and is to be understood that this particular shape shown is meant as an example only, and is not meant to limit the scope of this disclosure. Additionally, or alternatively, the second pillar garnish 112 may end at the body panel 102B of the vehicle 102 and may conform to the shape of the body panel 102B. In certain instances, the second pillar garnish 112 may be a safety barrier between the garnish gasket 108 and the body panel 102B of the vehicle 102. Additionally, the second pillar garnish 112 may reduce the gap 116 that may be formed between the fender cover 104 and the hood frame 114 of the vehicle 102.

The hood frame 114 may be a critical support structure that may be configured to place a hood over the engine space of the vehicle 102. In some instances, the hood may be hinged to the hood frame 114. The hood may provide access for maintenance and repairs while shielding the engine and its components from external weather.

The gap 116 may be formed between the fender cover 104 and the hood frame 114 of the vehicle 102. The gap 116 may be the smallest distance formed between the fender cover 104 and the hood frame 114. The gap 116 may alleviate any chances of the fender cover 104 colliding with the hood frame 114. Additionally, or alternatively, the gap 116 may reduce the wind noise. By way of example, and not limitation, the gap may be in a range between 0 mm and 5 mm.

FIG. 2 is a diagram that illustrates rib features provided on a top portion of a cowl associated with a mounting structure for a vehicle, about an YY section, in accordance with an embodiment of the disclosure. FIG. 2 is explained in conjunction with elements from FIG. 1A and FIG. 1B. With reference to the FIG. 2, there is shown a diagram 200 that may include rib features 202 provided on a top portion of the cowl 106.

The rib features 202 may be thin fins or web protrusions that are provided on the top portion of the cowl 106. The rib features 202 may be configured to mount the fender cover 104 on the cowl 106 of the vehicle 102. For example, the rib features 202 may be used to mount the fender cover 104 with the cowl 106 based on a press-fit of the rib features 202 and the fender cover 104. Based on the press-fit, the rib features 202 may form an interference fit between the fender cover 104 and the cowl 106. The interference fit may form a joint that holds the fender cover 104 and the cowl 106 together based on a friction that may occur after the fender cover 104 and the cowl 106 are pushed against each other. For example, the rib features 202 may provide strength to the fender cover 104 and the cowl 106 and may prevent unwanted sliding or bending. Further, the rib features 202 may improve assembly quality of the fender cover 104 and the cowl 106 by limiting requirement of additional attachment features.

It should be further noted that the diagram 200 of FIG. 2 is for exemplary purposes and should not be construed to limit the scope of the disclosure.

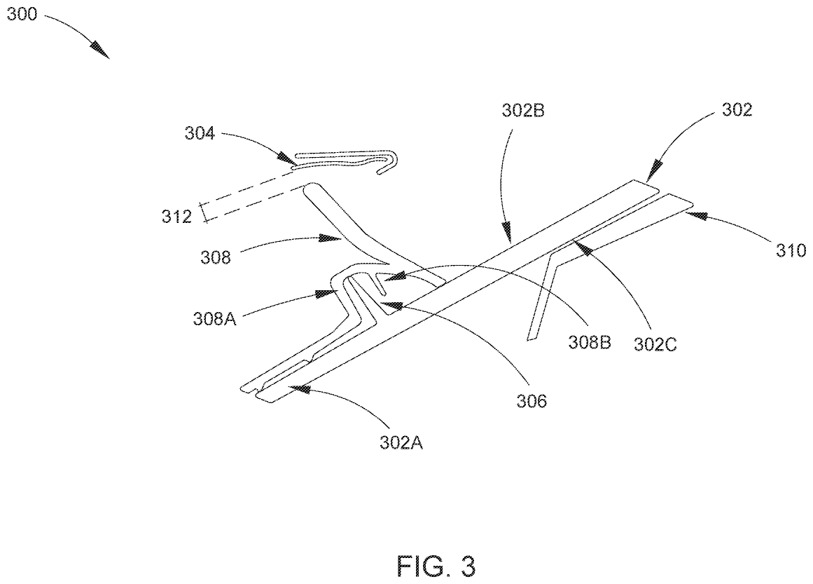

FIG. 3 is a scenario diagram that illustrates an exemplary implementation of a mounting structure, in accordance with an embodiment of the disclosure. FIG. 3 is explained in conjunction with elements from FIG. 1A, FIG. 1B, and FIG. 2. With reference to the FIG. 3, there is shown a scenario diagram that illustrates the mounting structure 300. The mounting structure 300 may include a first pillar garnish 302 having an end portion 302A, a first side 302B, and a second side 302C. The mounting structure 300 may further include a hood frame 304, a rib feature 306, a fender cover 308 having a shroud portion 308A and a web feature 308B, a second pillar garnish 310, and a gap 312.

It should be noted here that the mounting structure 300 as shown in FIG. 3 is an alternative implementation of a mounting structure (for example, a mounting structure 102A as shown in FIG. 1B). The description of the mounting structure 300, the first pillar garnish 302, the hood frame 304, the fender cover 308, and the second pillar garnish 310 has been omitted from the disclosure of the FIG. 3 for the sake of brevity.

The mounting structure 300 may be a support structure located at the A-pillar of the vehicle, on either side of the vehicle just forward of a rear facing windshield of the vehicle. The mounting structure 300 may include the first pillar garnish 302 that may be coupled with a body panel (not shown) of the vehicle. The first pillar garnish 302 may be disposed on the A-pillar of the vehicle and may conform to the shape of the A-pillar. Additionally, the first pillar garnish 302 may be coupled with the body panel to alleviate any concerns about the first pillar garnish 302 colliding with other components of the vehicle. In FIG. 3, the first pillar garnish 300 has a non-linear shape, which is merely an example that should not be construed as limiting the disclosure. Further description of the first pillar garnish 300 has been omitted from the disclosure for the sake of brevity.

The first pillar garnish 302 may further include the end portion 302A that may extend under the hood frame 304 of the vehicle. By way of example, and not limitation, the end portion 302A may be secured under the hood frame 304 using at least one of a nut and bolt, screws, rivets, hinges, or weld. In certain instances, the end portion 302A may substantially extend towards the fender cover 308 of the vehicle along a length of the first pillar garnish 302. The first pillar garnish 302 may include the first side 302B that may substantially face towards the fender cover 308 of the vehicle along a length of the first pillar garnish 302. The first pillar garnish 302 may include the second side 302C that may be different from the first side 302B and may face towards the second pillar garnish 310 or the body panel (not shown) of the vehicle.

The rib feature 306 may be a thin fin protrusion that is provided on the first side 302B of the first pillar garnish 302. The rib feature 306 may be configured to mount the fender cover 308, such that the gap 312 is formed between the fender cover 308 and the hood frame 304 of the vehicle. The rib feature 306 may be substantially perpendicular to the first side 302B of the first pillar garnish 302. The rib feature 306 may be a protruded section that may extend from the first side 302B of the first pillar garnish 302. The protruded section may be configured to mount the fender cover 308 of the vehicle. Additionally, the rib feature 306 may improve assembly quality of the fender cover 308 with the first pillar garnish 302 by limiting requirement of additional attachment features. Moreover, the fender cover 308 may further include a shroud portion 308A. The shroud portion 308A is shown to have a non-linear shape, which is merely an example that should not be construed as limiting the disclosure. The shroud portion 308A may be an extension that may be configured to enclose the rib feature 306 of the first pillar garnish 302. The fender cover 308 may further include a web feature 308B provided on the shroud portion 308A. The web feature 308B may be a thin web protrusion that may be configured to secure the rib feature 306 of the first pillar garnish 302. Additionally, the web feature 308B may be configured to grab the rib feature 306 of the first pillar garnish 302 based on a press-fit of the rib feature 306.

Further, the mounting structure 300 may include the second pillar garnish 310 that may be disposed on the second side 302C of the first pillar garnish 302. The second pillar garnish 310 may be disposed on the A-pillar of the vehicle and may conform to the shape of the A-pillar. Additionally, the second pillar garnish 310 may be coupled with the body panel (now shown) to alleviate any concerns regarding the first pillar garnish 302 colliding with other components of the vehicle. In FIG. 3, the second pillar garnish 310 is shown to have a non-linear shape, which is merely an example that should not be construed as limiting the disclosure. Further description of the second pillar garnish 310 has been omitted from the disclosure for the sake of brevity.

The gap 312 may be formed between the fender cover 308 and the hood frame 304 of the vehicle. In an embodiment, the gap 312 may be a smallest distance formed between the fender cover 308 and the hood frame 304. By way of example, and not limitation, the gap 312 may be in a range between 0 mm and 5 mm. The gap 312 may alleviate any chances of the fender cover 308 colliding with the hood frame 304 and may also help to reduce a wind noise.

It should be noted that the mounting structure 300 shown in FIG. 3 is for exemplary purposes and should not be construed to limit the scope of the disclosure.

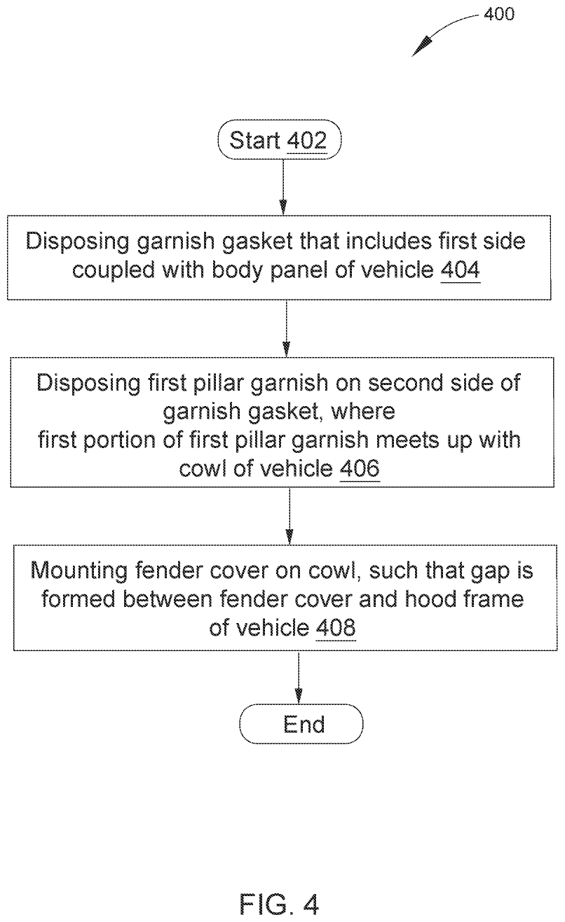

FIG. 4 is a flowchart that illustrates an exemplary method of mounting a fender cover on a cowl of a vehicle, in accordance with an embodiment of the disclosure. FIG. 4 is explained in conjunction with elements from FIG. 1A, FIG. 1B, FIG. 2, and FIG. 3. With reference to FIG. 4, there is shown a flowchart 400, which may depict a method of mounting the fender cover 104 with the cowl 106 of the vehicle 102. The method illustrated in the flowchart 400 may start at 402 and proceed to 404.

At 404, the first side 108A of the garnish gasket 108 may be coupled with the body panel 102B of the vehicle 102. Further details regarding coupling of the first side 108A with the body panel 102B, is described, in detail, for example, in FIG. 1A and FIG. 1B.

At 406, the first pillar garnish 110 may be disposed on the second side 108B of the garnish gasket 108. Further, the first portion 110A of the first pillar garnish 110 may meet up with the cowl 106 of the vehicle 102, as described in detail, for example, in FIG. 1A and FIG. 1B.

At 408, the fender cover 104 may be mounted on the cowl 106 of the vehicle 102, such that the gap 116 may be formed between the fender cover 104 and the hood frame 114 of the vehicle 102, as described in detail, for example, in FIG. 1A, FIG. 1B, and FIG. 2.

Although the flowchart 400 is illustrated as discrete operations, such as 402, 404, 406, and 408, the disclosure is not so limited. Accordingly, in certain embodiments, such discrete operations may be further divided into additional operations, combined into fewer operations, or eliminated, depending on the particular implementation without detracting from the essence of the disclosed embodiments.

For the purposes of the present disclosure, expressions such as “including”, “comprising”, “incorporating”, “consisting of”, “have”, “is” used to describe and claim the present disclosure are intended to be construed in a non-exclusive manner, namely allowing for items, components or elements not explicitly described also, to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible considering the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

What is claimed is:

1. A mounting structure for a vehicle, comprising:
a garnish gasket having a first side coupled with a body panel of the vehicle; and
a first pillar garnish disposed on a second side of the garnish gasket,
wherein a first portion of the first pillar garnish meets up with a cowl of the vehicle, and
the cowl is configured to mount a fender cover such that a gap is formed between the fender cover and a hood frame of the vehicle.

2. The mounting structure according to claim 1, wherein the garnish gasket includes an L shaped portion configured to receive a second pillar garnish on the first side of the garnish gasket.

3. The mounting structure according to claim 1, wherein the garnish gasket is disposed on an A pillar of the vehicle.

4. The mounting structure according to claim 1, wherein the garnish gasket is a mechanical seal that is configured to secure the first pillar garnish with the cowl of the vehicle and a second pillar garnish with the body panel of the vehicle.

5. The mounting structure according to claim 1, wherein the first pillar garnish and a second pillar garnish are disposed on an A pillar of the vehicle.

6. The mounting structure according to claim 1, wherein the body panel is disposed on at least lateral sides of the vehicle.

7. The mounting structure according to claim 1, wherein the first pillar garnish comprises:
the first portion that is substantially flushed to the cowl; and
a second portion that is substantially perpendicular to the first portion and disposed on the second side of the garnish gasket.

8. The mounting structure according to claim 1, wherein the cowl further comprises:
rib features that are provided on a top portion of the cowl and is configured to mount the fender cover on the cowl.

9. The mounting structure according to claim 8, wherein the rib features mount the fender cover on the cowl based on a press-fit of the rib features and the fender cover.

10. The mounting structure according to claim 1, wherein the fender cover is a wheel well which is positioned over at least a front wheel assembly of the vehicle.

11. A mounting structure for a vehicle, comprising:
a first pillar garnish coupled with a body panel of the vehicle,
wherein an end portion of the first pillar garnish extends under a hood frame of the vehicle; and
a rib feature provided on a first side of the first pillar garnish,
wherein the rib feature is configured to mount a fender cover such that a gap is formed between the fender cover and the hood frame of the vehicle.

12. The mounting structure according to claim 11, further comprising a second pillar garnish disposed on a second side of the first pillar garnish and coupled with the body panel of the vehicle.

13. The mounting structure according to claim 11, wherein the first pillar garnish and a second pillar garnish is disposed on an A pillar of the vehicle.

14. The mounting structure according to claim 11, wherein,
the rib feature is substantially perpendicular to the first side of the first pillar garnish; and
the rib feature is a protruded section that is configured to mount the fender cover of the vehicle.

15. The mounting structure according to claim 11, wherein the fender cover further comprises:
a shroud portion that may be configured to enclose the rib feature of the first pillar garnish; and
a web feature that may be configured to secure the rib feature of the first pillar garnish.

16. A method of mounting a fender cover on a cowl of a vehicle, the method comprising:
coupling a first side of a garnish gasket with a body panel of the vehicle;
disposing a first pillar garnish on a second side of the garnish gasket,
wherein a first portion of the first pillar garnish meets up with the cowl of the vehicle; and
mounting the fender cover on the cowl, such that a gap is formed between the fender cover and a hood frame of the vehicle.

17. The method according to claim 16, wherein the garnish gasket includes an L shaped portion configured to receive a second pillar garnish on the first side of the garnish gasket.

18. The method according to claim 16, wherein,
the garnish gasket is disposed on an A pillar of the vehicle, and
the garnish gasket is a mechanical seal that is configured to secure the first pillar garnish with the cowl of the vehicle and a second pillar garnish with the body panel of the vehicle.

19. The method according to claim 16, wherein the first pillar garnish comprises:
the first portion that is substantially flushed to the cowl; and
a second portion that is substantially perpendicular to the first portion and disposed on the second side of the garnish gasket.

20. The method according to claim 16, wherein the cowl further comprises:
rib features that are provided on a top portion of the cowi and is configured to mount the fender cover on the cowl.
